(19) United States
(12) Patent Application Publication
(10) Pub. No.: US 2024/0338291 A1
(43) Pub. Date: Oct. 10, 2024

(54) DISCOVERING AN INVALID PERFORMANCE VALUE

(71) Applicant: INTERNATIONAL BUSINESS MACHINES CORPORATION, Armonk, NY (US)

(72) Inventors: Bo Chen ZHU, Xi'an (CN); Chu Yun TONG, Beijing (CN); Peng Hui JIANG, Beijing (CN); Cheng Fang WANG, Shangdi (CN)

(21) Appl. No.: 18/132,154

(22) Filed: Apr. 7, 2023

(51) Int. Cl. G06F 11/34

(52) U.S. Cl. CPC G06F 11/3409

(57) ABSTRACT

A method, system, and computer program product that is configured to: create a three dimensional space by analyzing historical performance data; find an edge surface in the three dimensional space by determining a curve which intersects a plane in the three dimensional space; build a filter based on the edge surface in the three dimensional space; perform a logical operation between raw performance data and the built filter; determine whether the raw performance data has an invalid data value based on a result of the logical operation between the raw performance data and the built filter; and generate an alert that indicates that the raw performance data has the invalid data value in multiple data values in response to determining that a number of raw performance data instances having the invalid data value reaches a predetermined threshold counter number.

### BACKGROUND

Aspects of the present invention relate generally to discovering an invalid performance value and, more particularly, to discovering an invalid performance value from agent data aggregation.

In an application performance management (APM) system, an APM agent collects raw performance data and then formats and passes the raw performance data to a report and analytics platform after aggregation by an agent. In particular, the raw performance data is stored as a piece of system memory with a specified mapping reference. The agent locates and copies the content of the system memory and then formats the content according to the specified mapping reference.

### SUMMARY

In a first aspect of the invention, there is a computer-implemented method including: creating, by a processor set, a three dimensional space by analyzing historical data of raw performance data; finding, by the processor set, an edge surface in the three dimensional space by determining a curve which intersects a plane in the three dimensional space; building, by the processor set, a filter based on the edge surface in the three dimensional space; performing, by the processor set, a logical operation between raw performance data and the built filter; determining, by the processor set, whether the raw performance data has an invalid data based on a result of the logical operation between the raw performance data and the built filter; and generating, by the processor set, an alert that indicates that the raw performance data has the invalid data value in multiple data values in response to determining that a number of raw performance data instances having the invalid data value reaches a predetermined threshold counter number.

In another aspect of the invention, there is a computer program product including one or more computer readable storage media having program instructions collectively stored on the one or more computer readable storage media. The program instructions are executable to: create a three dimensional space by analyzing historical data of raw performance data; find an edge surface in the three dimensional space by determining a curve which intersects a plane in the three dimensional space; build a filter based on the edge surface in the three dimensional space; perform a logical operation between raw performance data and the built filter; determine whether the raw performance data has an invalid data based on a result of the logical operation between the raw performance data and the built filter; and send the raw performance data to a record table in response to a determination that the raw performance data has the invalid data value.

In another aspect of the invention, there is a system including a processor set, one or more computer readable storage media, and program instructions collectively stored on the one or more computer readable storage media. The program instructions are executable to: create a three dimensional space by analyzing historical data of raw performance data; find an edge surface in the three dimensional space by determining a curve which intersects a plane in the three dimensional space; build a filter based on the edge surface in the three dimensional space; perform a logical operation between raw performance data and the built filter; determine whether the raw performance data has an invalid data based on a result of the logical operation between the raw performance data and the built filter; send the raw performance data to a record table in response to a determination that the raw performance data has the invalid data value; and monitor the raw performance data over a predetermined interval to determine whether a number of raw performance data instances having the invalid data value reaches a predetermined threshold counter number.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method of an invalid value analysis in accordance with aspects of the present invention.

FIG. 4 shows an example of a distribution graph in accordance with aspects of the present invention.

FIG. 5 shows an example of a surface discovery in the distribution graph in accordance with aspects of the present invention.

FIG. 6 shows a flowchart of an exemplary method of building a filter in accordance with aspects of the present invention.

FIG. 7 shows an example of the built filter in accordance with aspects of the present invention.

FIG. 8 shows a block diagram of a record counter module in accordance with aspects of the present invention.

FIG. 9 shows a block diagram of an invalid record heap module in accordance with aspects of the present invention.

### DETAILED DESCRIPTION

Aspects of the present invention relate generally to discovering an invalid performance value and, more particularly, to discovering an invalid performance value from agent data aggregation. Embodiments of the present invention identify an invalid performance data value caused by a residue high bit. Embodiments of the present invention analyze historical data by formatting data and creating a three dimensional feature space. Embodiments of the present invention build a new filter (i.e., a slot) using a dynamic length slot for each performance metric during a collection process. Embodiments of the present invention process real-time raw data and use the built filter to identify and filter performance data with invalid values along with collection and aggregation. Embodiments of the present invention use a new heap with a counter to store temporary invalid data to prevent an incorrect filter due to a system change. Embodiments of the present invention adopt the slot length and recover the filtered value in response to the filtered value being valid. In this manner, implementations of the invention discover invalid data value in a quick and efficient manner with a low system cost.

Implementations of the present invention provide a technical solution to a technical problem of a memory in a system not being correctly cleared due to an incorrect programming, unreasonable shared memory management, or unpredictable system behavior. In embodiments, the technical solution includes identifying and filtering an invalid performance data value caused by residue in a high bit of the memory.

Implementations of the present invention have a practical application of improving data reliability within a memory by identifying and filtering an invalid performance data value caused by residue in a high bit of the memory. Further, implementations of the present invention quickly filter the invalid performance data value using a dynamic length slot. Implementations of the present invention are also able to recover the filtered data value in response to the filtered data value being valid by adopting the dynamic slot length. Implementations of the present invention are also able to be leveraged in different systems and analysis solutions.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as invalid performance value detection code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

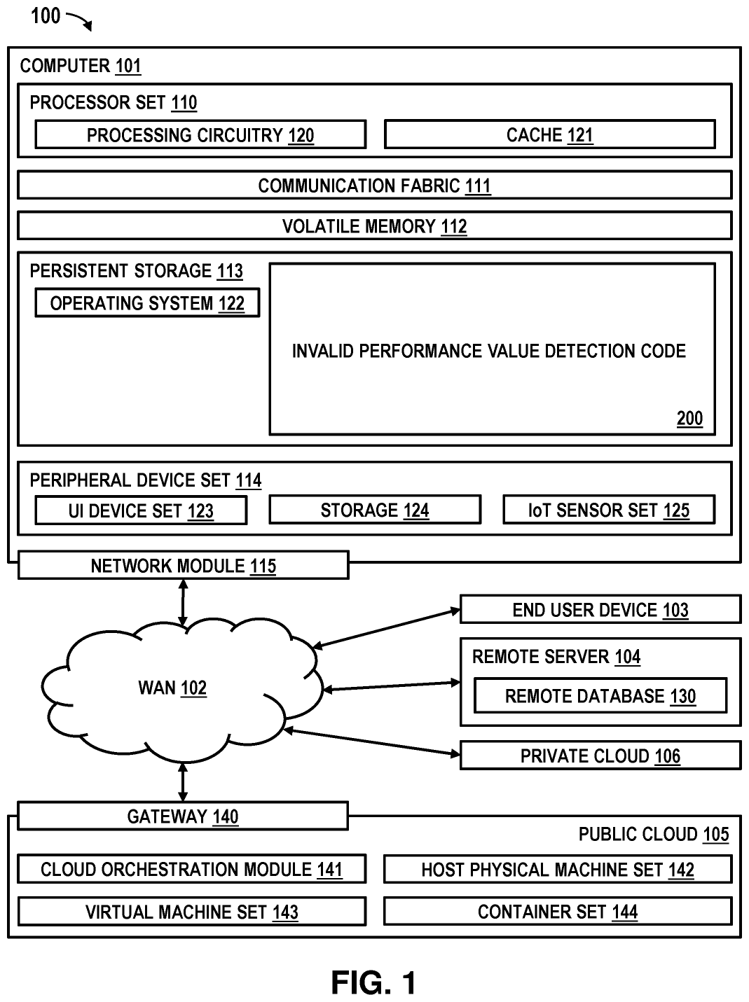

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

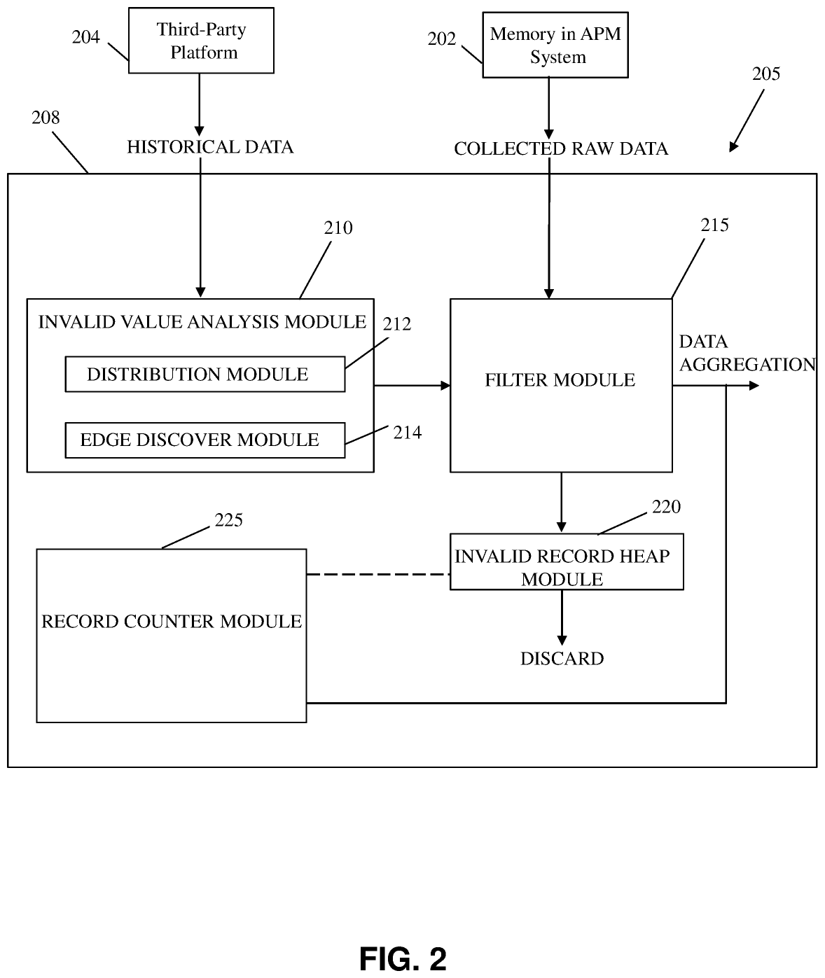

FIG. 2 shows a block diagram of an exemplary environment 205 in accordance with aspects of the invention. In embodiments, the environment 205 includes invalid data value discovery device 208, which may comprise one or more instances of the computer 101 of FIG. 1.

In embodiments, the invalid data value discovery device 208 of FIG. 2 comprises an invalid value analysis module 210, distribution module 212, edge discover module 214, filter module 215, invalid record heap module 220, and record counter module 225, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The invalid data value discovery device 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, the invalid value analysis module 210 receives historical data of raw performance data from a performance data source, such as a third-party platform 204 or memory included in an application performance management (APM) system 202. In embodiments, the raw performance data is stored in memory in the APM system 202 and the historical data of the raw performance data is stored in the third-party platform 204. Also, raw performance data is data which is collected by an application performance management (APM) agent. The historical data of the raw performance data comprises historical values of the raw performance data and also includes performance data within a subsection of the historical data (e.g., the performance data may be contained in the lower bits). For example, the historical data of the raw performance data may be a binary value of “000010001”. However, a current data of the raw performance data may be a binary value of “100010001”. In embodiments, the current data of the raw performance data may include a high bit residue of “1” in the highest bit. Aspects of the present invention are used to detect the high bit residue in order to determine when the current data of the raw performance data is incorrect by comparing the current data of the raw performance data with the historical data of the raw performance data. Aspects of the present invention also generate an alert when the high residue bit is detected and send the alert to memory included in the APM system 202.

The invalid value analysis module 210 fetches performance data from the historical data. In particular, the performance data of the historical value includes a value v and a corresponding timestamp for each performance metric of the historical data. The distribution module 212 serializes the performance data by formatting the corresponding timestamp to a time in the day such that the performance data becomes value v and time pair t (i.e., v, t). Then, the distribution module 212 groups the performance data by days so that the time is unique in each set.

In aspects of the present invention, the distribution module 212 performs decomposition of the binary value of the performance data. In particular, for each performance value v, the distribution module 212 processes the decomposition by the following Formula:

$$v = {\sum }_{i = 1}^{m} {b}_{i} {2}^{i} ( {b}_{i} ∈ [ 0 , 1 ] ) . \qquad ( Formula 1 )$$

The distribution module 212 determines the B-value (i.e., B refers to a high bit usage) in accordance with the following Formula:

$$B = {max}_{{b}_{i} = 1} i . \qquad ( Formula 2 )$$

The distribution module 212 then formats the data sets of B-value and time as (B, t). The distribution module 212 creates a three dimensional B-value performance data space using xyz axes. In particular, the x axis is represented by s, which is a data set number, the y axis is represented by t, which represents the time, and the z axis is represented by B, which is the B-value or high bit usage. In the three dimensional B-value performance data space, the default planes are s=sᵢ, which means that the data set number corresponds with the set of the high bit usage sᵢ and t=tᵢ, which means that the time corresponds with the time of the high bit usage tᵢ.

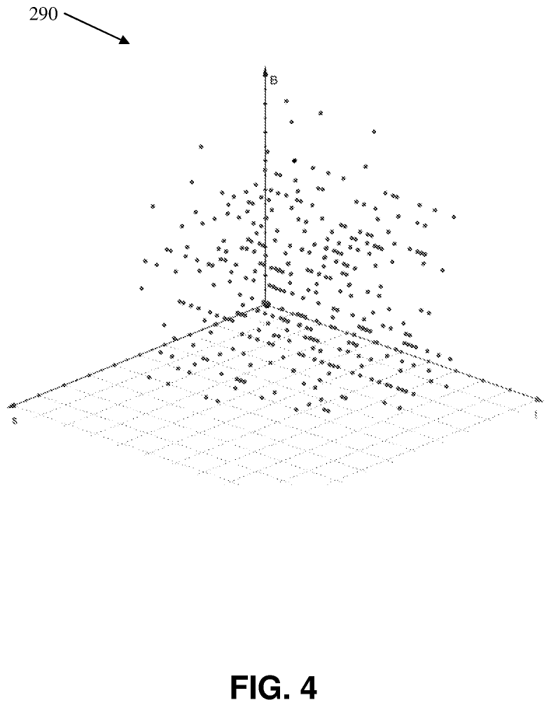

The distribution module 212 creates a distribution in which the data sets are numbered as s and each point (s, t, B) is distributed into the data space. Each point (s, t, B) of the distribution is a record of data. A distribution graph 290 in the three dimensional space is described in more detail in FIG. 4.

The edge discover module 214 generates a formula and condition for a plane within the distribution. In particular, the edge discover module 214 uses the distribution in the three dimensional space from the distribution module 212 and finds a surface in which B=w(t). The edge discover module 214 then finds a curve which is located where B=w(t) intersects with plane s=sᵢ as Cᵢ=fᵢ(t). In particular, Cᵢ is an intersection point of all three axes and a surface. The edge discover module 214 then finds a fitting curve of Sᵢ=gᵢ(t). The edge discover module 214 finds a distance d between B=w(t) and (s, 0, t). The edge discover module 214 isolates a unique surface H=w(t), for all s=sᵢ with a minimum distance d and (s, t, B) is discrete when Sᵢ>Cᵢ.

The edge discover module 214 finds H=w(t) by using a surface fitting technology which uses a direction as B for the z axis vector iteration in accordance with the following Formula:

$$H = w ( t ) = {\sum }_{i = 1}^{m} {a}_{i} {t}^{i} + b . \qquad ( Formula 3 )$$

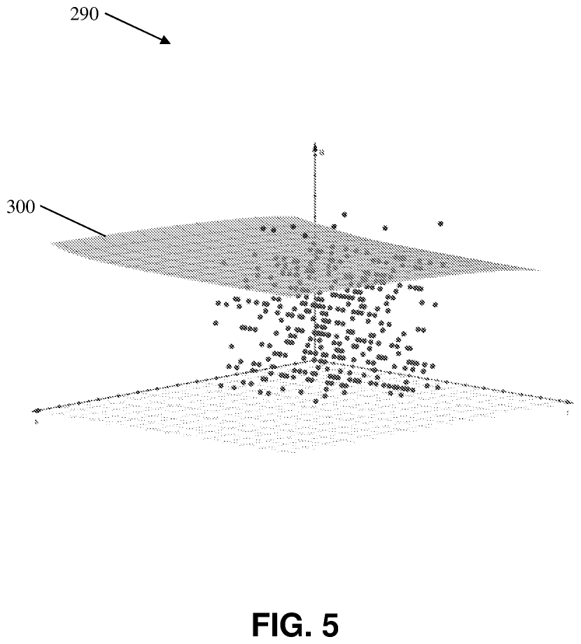

In Formula 3, the edge discover module 214 finds a parameter set (a₁, . . . , aₘ) using surface fitting techniques and finds b by using an edge condition in a data approximation method with a minimum distance d and (s, t, B) is discrete when Sᵢ>Cᵢ. Thus, the edge discover module 214 finds the unique surface H=w(t) and also finds points above the unique surface H=w(t) as candidates having a high bit residue (i.e., invalid data value at a high bit of memory). The edge discover module 214 identifies the unique surface H=w(t) as the edge surface. In particular, the edge discover module 214 outputs the edge surface (i.e., H=w(t)) from the invalid value analysis module. An example of the surface discovery is described in more detail in FIG. 5.

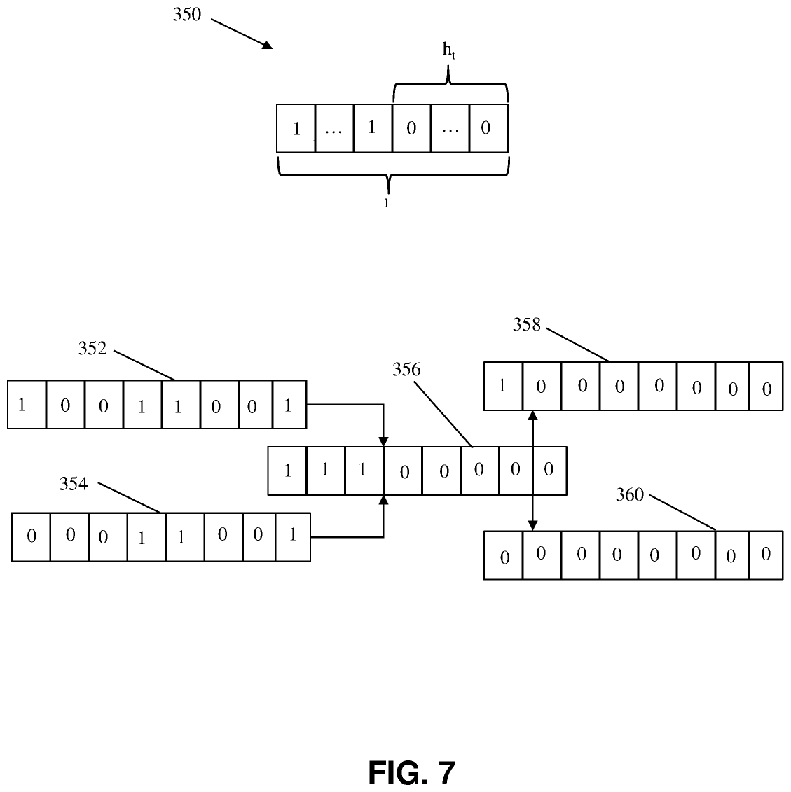

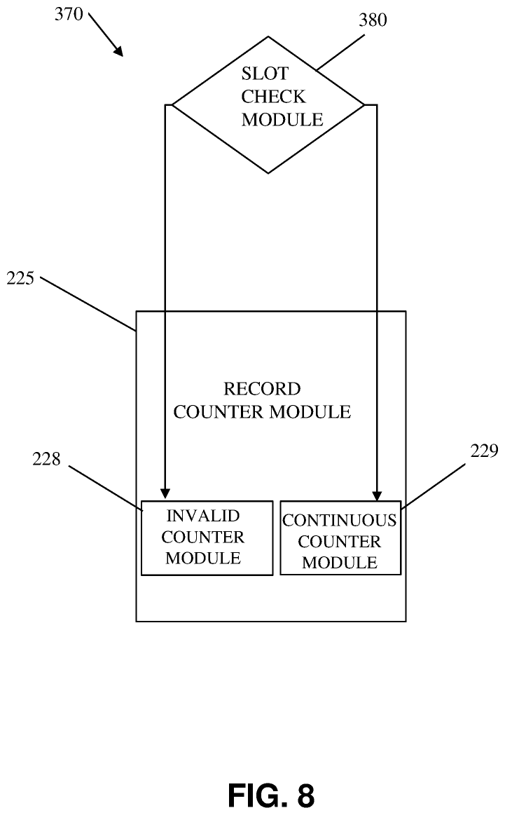

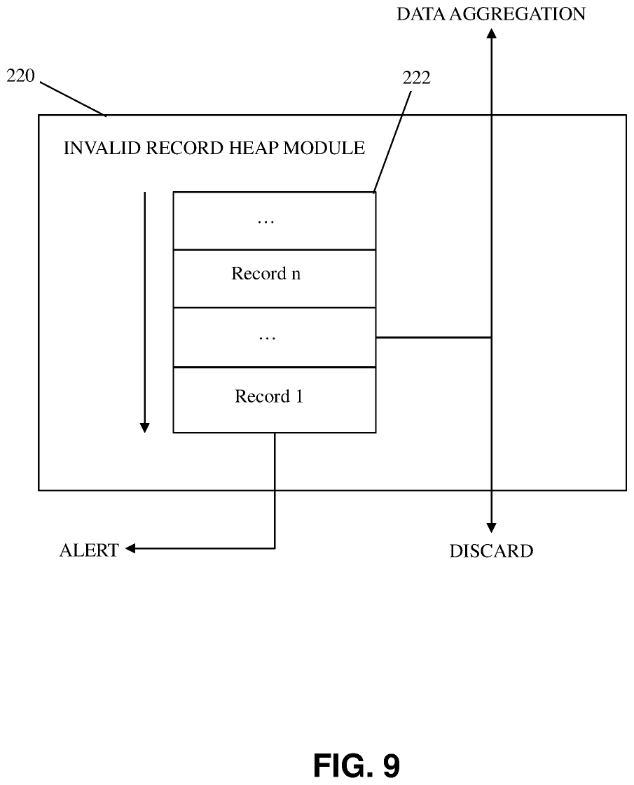

In aspects of the present invention, the invalid value analysis module 210 sends the edge surface (i.e., H=w(t)) to the filter module 215. The filter module 215 also receives collected raw performance data from memory included in the application performance management (APM) system 202. In particular, the filter module 215 builds a filter (i.e., a slot) using the edge surface (i.e., H=w(t)) and formats the filter for each time point such that the value of H is identified as hₜ. In the filter module 215, h(t) is considered as a length of the filter and the length of the raw performance data as 1 (as shown in greater detail in FIG. 7). The filter module 215 generates the filter based on hₜ. In the filter module 215, a logical AND operation (i.e., a slot check operation) occurs between the filter and the raw performance data. In response to the output of the AND operation having a value=zero (i.e., flagged as a pass), then the raw performance data is valid data and the valid raw performance data is output to a data aggregation system (not shown). In response to the output of the AND operation having a value greater than zero (i.e., flagged as a failure), then the raw performance data has a high bit residue (i.e., invalid data value) and is sent to the invalid record heap module 220. Further, a record counter module 225 monitors the status when the high bit residue is sent to the invalid record heap module 220. Further, embodiments are not limited to only AND operations, and other logic operations may be used to determine whether the raw performance data has the high bit residue. Details of the invalid record heap module 220 and the record counter module 225 are described in FIGS. 8 and 9.

In aspects of the present invention, the invalid record heap module 220 receives the raw performance data as the high bit residue (i.e., invalid data value). The invalid record heap module 220 stores the raw performance data as the high bit residue in a record table. In the invalid record heap module 220, when a number of records stored in the record table reaches a predetermined threshold record number within a predetermined monitoring interval, the invalid record heap module 220 generates an alert that the system and/or program needs to be checked to ensure that there isn't a systemic risk to the system and/or program that is causing an impact to data reliability in multiple data values. In embodiments, the alert may also be generated when an invalid counter in the record counter module 225 reaches a predetermined threshold counter number within the predetermined monitoring interval. Further, the invalid record heap module 220 outputs the raw performance data to data aggregation in response to an exception in a continuous counter in the record counter module 225. In this scenario, the raw performance data is determined to not be identified correctly (i.e., is not an invalid data value). Therefore, in this scenario, the raw performance data is valid data that should be output to data aggregation. The invalid record heap module 220 discards the raw performance data in response to no exception in the continuous counter in the record counter module 225. Further details of the invalid record heap module 220 are described in FIG. 9.

In aspects of the present invention, the record counter module 225 monitors the invalid record heap module 220 as indicated by the dashed line in FIG. 2. The record counter module 225 includes the invalid counter and the continuous counter. In particular, in response to the raw performance data being sent to the invalid record heap module 220 (i.e., the raw performance data has the invalid data value), the invalid counter is increased by one. The invalid counter is set with the predetermined threshold counter number which corresponds with how often the raw performance data can be the invalid data value within the predetermined monitoring interval before the alert is generated. For example, in response to the predetermined threshold counter number being two, if there are more than two raw performance data instances which have the invalid data value within the predetermined monitoring interval, an alert is generated. The invalid counter is then cleared at the end of every predetermined monitoring interval. The record counter module 225 also includes the continuous counter which is a 1-bit binary counter with a default value of zero. In response to the raw performance data being sent to the invalid record heap module 220, one is added to the continuous counter. Then, in response to the raw performance data passing the filter in the value slot module (i.e., the raw performance is valid data), a logical AND operation is performed with the value in the continuous counter. However, in response to two consecutive instances of the raw performance data being sent to the invalid record heap module (continuous counter=2), an overlay exception is generated and the raw performance data is determined to not be identified correctly (i.e., is not invalid data value). Therefore, in this scenario, raw performance data is valid data that should be output to data aggregation. In this scenario, the two consecutive instances of the raw performance data are sent to the data aggregation for further processing.

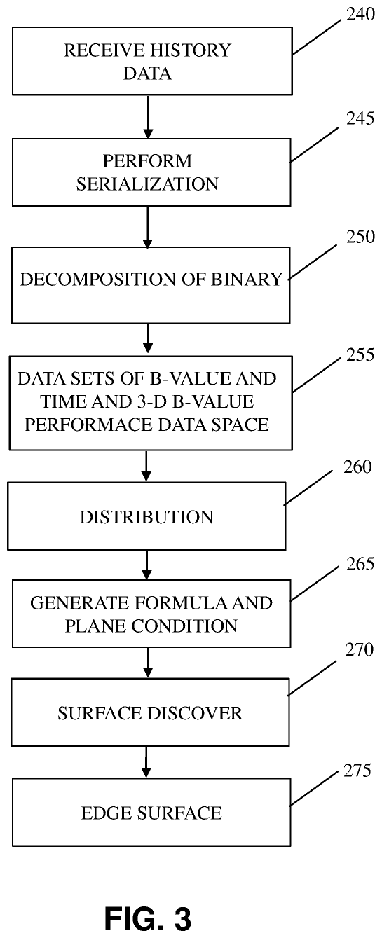

FIG. 3 shows a flowchart of an exemplary method of an invalid value analysis in accordance with aspects of the present invention. Steps of the method may be carried out in the environment of FIG. 2 and are described with reference to elements depicted in FIG. 2.

At step 240, the system receives, at the invalid value analysis module 210, historical data. In embodiments, and as described with respect to FIG. 2, the invalid value analysis module 210 fetches performance data with the value v and the corresponding timestamp for each performance metric of the historical data. At step 245, the system performs, at the distribution module 212, serialization of the performance data by formatting the corresponding timestamp to a time in the day. In embodiments, and as described with respect to FIG. 2, each data point of the performance data becomes a value v and time pair t (i.e., v, t) after the serialization of the performance data. The distribution module 212 also groups the performance data by days so that the time is unique in each set. At step 250, the system performs, at the distribution module 212, decomposition of the binary. In embodiments, and as described with respect to FIG. 2, for each performance value v, the distribution module 212 processes the decomposition by using Formula 1 and makes the B-value (i.e., B refers to a high bit usage) in accordance with Formula 2. At step 255, the system formats, at the distribution module 212, the data sets of B-value and time as: (B, t). Further, at step 255, the system creates, at the distribution module 212, the three dimensional B-value performance data space using xyz axes. In embodiments, and as described with respect to FIG. 2, the x axis is represented by s, which is a data set number, the y axis is represented by t, which represents the time, and the z axis is represented by B, which is the B-value or high bit usage. In the three dimensional B-value performance data space, the default planes are s=sᵢ, which means that the data set number corresponds with the set of the high bit usage sᵢ and t=tᵢ, which means that the time corresponds with the time of the high bit usage tᵢ.

At step 260, the system creates, at the distribution module 212, the distribution in which the data sets are numbered as s and each point (s, t, B) are distributed into the data space. In embodiments, and as described with respect to FIG. 2, each point (s, t, B) of the distribution is a record of data. At step 265, the system generates, at the edge discover module 214, a formula and condition for the plane. In embodiments, and as described with FIG. 2, the edge discover module 214 uses the distribution in the three dimensional space from the distribution module 212 and find a surface in which B=w(t). The edge discover module 214 then finds a curve which is located when B=w(t) intersects with plane s=sᵢ as Cᵢ=fᵢ(t). In particular, Cᵢ is an intersection point of all three axes and a surface. The edge discover module 214 then finds a fitting curve of Sᵢ=gᵢ(t). The edge discover module 214 finds a distance d between B=w(t) and (s, 0, t). The edge discover module 214 isolates a unique surface H=w(t), for all s=sᵢ with a minimum distance d and (s, t, B) is discrete when Sᵢ>Cᵢ.

At step 270, the system discovers, at the edge discover module 214, a surface by using a direction as B for the z axis vector iteration in accordance with Formula 3. In embodiments, and as described with FIG. 2, the parameter set (a₁, . . . , aₘ) of Formula 3 is identified by a surface fitting technology and b is identified by an edge condition in a data approximation method with a minimum distance d and (s, t, B) is discrete when Sᵢ>Cᵢ. At step 275, the system identifies, the edge surface. In embodiments, and as described with FIG. 2, the unique surface H=w(t) is found and points above the unique surface H=w(t) are identified as candidates having a high bit residue (i.e., invalid data value at a high bit of memory). The unique surface H=w(t) is identified as the edge surface which is output from the invalid value analysis module 210 to the filter module 215.

FIG. 4 shows an example of a distribution graph in accordance with aspects of the present invention. In particular, the distribution graph 290 in FIG. 4 includes a distribution in which the data sets are numbered as s. In particular, the distribution graph 290 is an example of the distribution created by the distribution module 212 in FIG. 2. Further, each point of the distribution graph 290 are distributed into a data space based on the data set s (i.e., the x-axis), the time t (i.e., the y-axis), and the B-value (i.e., the z-axis).

FIG. 5 shows an example of a surface discovery in the distribution graph in accordance with aspects of the present invention. In the distribution graph 290, an edge surface 300 is shown which is represented as unique surface H=w(t). In particular, the edge surface 300 is an example of a surface which is isolated by the edge discover module 214. In FIG. 5, points above the edge surface 300 (i.e., the unique surface H=w(t)) are identified as candidates for having a high bit residue (i.e., invalid data value at a high bit of memory).

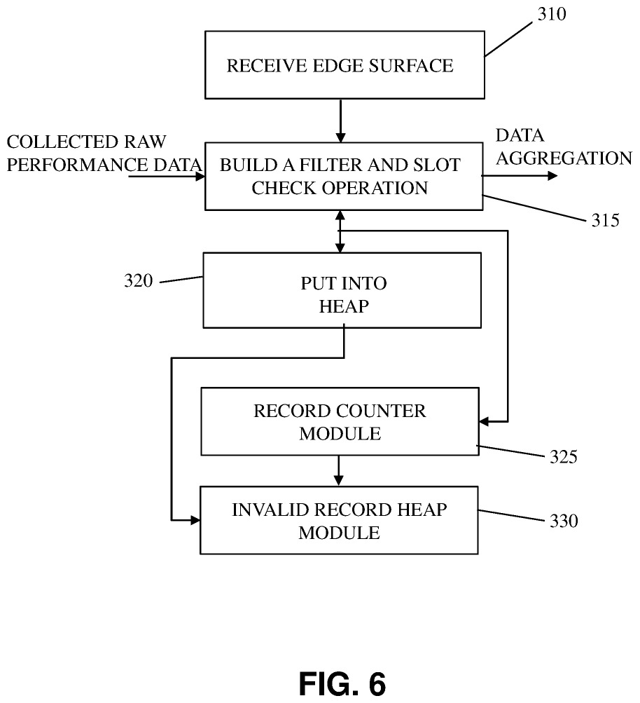

FIG. 6 shows a flowchart of an exemplary method of building a filter in accordance with aspects of the present invention. Steps of the method may be carried out in the environment of FIG. 2 and are described with reference to elements depicted in FIG. 2.

At step 310, the system receives, at the filter module 215, the edge surface from the invalid value analysis module 210. At step 315, the system also receives, at the filter module 215, the collected raw performance data from the memory in the APM system 202. Further, at step 315, the system builds, at the filter module 215, a filter (i.e., a slot) using the edge surface (i.e., H=w(t)), formats the filter for each time point such that the value of H is identified as h(t), and performs a slot check operation. In embodiments, and as described with FIG. 2, in the filter module 215, h(t) is considered as a length of the filter (i.e., the slot) and the length of the raw performance data as 1. The filter module 215 generates the filter (i.e., the slot) based on h(t). In the filter module 215, a logical AND operation (i.e., the slot check operation) occurs between the filter (i.e., the slot) and the raw performance data. In response to the output of the logical AND operation (i.e., the slot check operation) having a value=zero (i.e., flagged as a pass), the raw performance data is valid data and the valid raw performance data is output to data aggregation.

At step 320, the system puts, by the filter module 215, the raw performance data into a heap in response to the output of the logical AND operation (i.e., the slot check operation) having a value greater than zero (i.e., flagged as a failure). In embodiments, and as described with FIG. 2, in this situation, the raw performance data is identified as having a high bit residue (i.e., invalid data value). At step 330, the system sends, by the filter module 215, the raw performance data identified as having the high bit residue to the invalid record heap module 220. At step 325, the system monitors, by the record counter module, the status when the high bit residue (i.e., invalid data value) is sent to the invalid record heap module 220.

FIG. 7 shows an example of the built filter in accordance with aspects of the present invention. In FIG. 7, a template slot 350 for building a filter 356 (e.g., slot) is created in which hₜ is the length of the slot and 1 is the length of the performance data. In particular, the filter 356 is built by using hₜ from the template slot 350. In embodiments, hₜ is identified as the value of H for each time point of H=w(t) (i.e., the edge surface).

In aspects of the present invention, in response to the filter 356 being built in FIG. 7, a logical AND operation is performed between the filter 356 and raw performance data. In the example of FIG. 7, a logical AND operation is performed between a first raw performance data 352 and the filter 356. A result of the logical AND operation between the first raw performance data 352 and the filter 356 is shown as a failed result 358. The failed result 358 is a failure because the result of the logical AND operation between the first raw performance data 352 and the filter 356 is greater than 0 (which indicates that the first raw performance data 352 has an invalid data value and a high bit residue). In another example shown in FIG. 7, a logical AND operation is performed between a second raw performance data 354 and the filter 356. A result of the logical AND operation between the second raw performance date 354 and the filter is shown as a passed result 360. The passed result 360 is passed because the result of the logical AND operation between the second raw performance data 354 and the filter 358 is equal to 0 (which indicates that the second raw performance data 354 has a valid data value).

FIG. 8 shows a block diagram 370 of the record counter module 225 and a slot check module 380 in accordance with aspects of the present invention. The record counter module 225 further includes an invalid counter module 228 and a continuous counter module 229. In embodiments, and as described with FIG. 2, the record counter module 225 monitors the invalid record heap module 220 as indicated by the dashed line in FIG. 2. In particular, in response to the raw performance data being sent from the slot check module 380 of the filter module 215 to the invalid record heap module 220 (i.e., the raw performance data has the invalid data value), an invalid counter of the invalid counter module 228 is increased by one. The invalid counter is set with the predetermined threshold counter number which corresponds with how often the raw performance data can be the invalid data value within the predetermined monitoring interval before an alert is generated. For example, in response to the predetermined threshold counter number being two and more than two raw performance data instances have the invalid data value within the predetermined monitoring interval, an alert is generated. The invalid counter is then cleared at the end of every predetermined monitoring interval.

In aspects of the present invention, a continuous counter of the continuous counter module 229 is a 1-bit binary counter with a default value of zero. In response to the raw performance data being sent from the slot check module 380 of the filter module 215 to the invalid record heap module 220, one is added to the continuous counter of the continuous counter module 229. Then, in response to the raw performance data passing the filter in the slot check module 380 of the filter module 215 (i.e., the raw performance is valid data), a logical AND operation is performed with the value in the continuous counter of the continuous counter module 229. However, in response to two consecutive instances of the raw performance data being sent to the invalid record heap module 220 (continuous counter=2 of the continuous counter module 229), an overlay exception is generated and there is a determination that the raw performance data is determined to not be identified correctly (i.e., is not invalid data value). Therefore, in this scenario, the raw performance data is now determined to be valid data that should be output to data aggregation. In other words, the two consecutive instances of the raw performance data are sent to the data aggregation for further processing.

FIG. 9 shows a block diagram of an invalid record heap module in accordance with aspects of the present invention. The invalid record heap module 220 receives the raw performance data as the high bit residue (i.e., invalid data value). The invalid record heap module 220 stores the raw performance data as the high bit residue (i.e., invalid data value) in a record table 222. In the invalid record heap module 220, when a number of records stored in the record table 222 reaches a predetermined threshold record number within the predetermined monitoring interval, the alert is generated to indicate that the system and/or program needs to be checked to ensure that there isn't a systemic risk to the system and/or program that is causing an impact to data reliability in multiple data values. In embodiments, the alert may also be generated in response to an invalid counter in the invalid counter module 228 of the record counter module 225 reaching a predetermined threshold counter number within the predetermined monitoring interval. Further, the invalid record heap module 220 outputs the raw performance data to data aggregation in response to an exception in a continuous counter in the continuous counter module 229 of the record counter module 225. In this scenario, the raw performance data is determined to not be identified correctly (i.e., is not invalid data value). Therefore, the raw performance data is now determined to be valid data that should be output to data aggregation. The invalid record heap module 220 discards the raw performance data in response to no exception being generated in the continuous counter in the continuous counter module 229 of the record counter module 225.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
creating, by a processor set, a three dimensional space by analyzing historical data of raw performance data;
finding, by the processor set, an edge surface in the three dimensional space by determining a curve which intersects a plane in the three dimensional space;
building, by the processor set, a filter based on the edge surface in the three dimensional space;
performing, by the processor set, a logical operation between the raw performance data and the built filter;
determining, by the processor set, whether the raw performance data has an invalid data value based on a result of the logical operation between the raw performance data and the built filter; and
generating, by the processor set, an alert that indicates that the raw performance data has the invalid data value in multiple data values in response to determining that a number of raw performance data instances having the invalid data value reaches a predetermined threshold counter number.

2. The method of claim 1, wherein the three dimensional space includes a data space defined by a data set number, a time, and a high bit usage.

3. The method of claim 2, wherein the three dimensional space comprises a distribution of the historical data of the raw performance data in the data space defined by the data set number, the time, and the high bit usage

4. The method of claim 1, wherein the analyzing the historical data of the raw performance data comprises fetching a value and timestamp of the historical data of the raw performance data.

5. The method of claim 1, wherein the built filter is based on a value of the edge surface at each time point.

6. The method of claim 1, wherein the logical operation performed between the raw performance data and the built filter comprises a logical AND operation.

7. The method of claim 1, wherein the raw performance data is determined to have the invalid data value in response to the result of the logical operation between the raw performance data and the built filter having a value greater than zero.

8. The method of claim 1, wherein the raw performance data is determined to have a valid data value in response to the result of the logical operation between the raw performance data and the built filter having a value equal to zero.

9. The method of claim 1, further comprising monitoring the raw performance data over a predetermined interval to determine whether the number of raw performance data instances having the invalid value reaches the predetermined threshold counter number.

10. The method of claim 9, further comprising sending the alert to memory included in an application program management (APM) system.

11. The method of claim 1, further comprising sending the raw performance data to a record table in response to a determination that the raw performance data has the invalid data value.

12. A computer program product comprising one or more computer readable storage media having program instructions collectively stored on the one or more computer readable storage media, the program instructions executable to:
create a three dimensional space by analyzing historical data of raw performance data;
find an edge surface in the three dimensional space by determining a curve which intersects a plane in the three dimensional space;
build a filter based on the edge surface in the three dimensional space;
perform a logical operation between raw performance data and the built filter;
determine whether the raw performance data has an invalid data value based on a result of the logical operation between the raw performance data and the built filter; and
send the raw performance data to a record table in response to a determination that the raw performance data has the invalid data value.

13. The computer program product of claim 12, wherein the logical operation performed between the raw performance data and the built filter comprises a logical AND operation.

14. The computer program product of claim 13, wherein the raw performance data is determined to have the invalid data value in response to the result of the logical AND operation between the raw performance data and the built filter having a value greater than zero.

15. The computer program product of claim 12, further comprising monitoring the raw performance data over a predetermined interval to determine whether a number of raw performance data instances having the invalid value reaches a predetermined threshold counter number.

16. The computer program product of claim 15, further comprising generating an alert in response to determining that the number of raw performance data instances having the invalid value reaches the predetermined threshold counter number.

17. A system comprising:
a processor set, one or more computer readable storage media, and program instructions collectively stored on the one or more computer readable storage media, the program instructions executable to:
create a three dimensional space by analyzing historical data of raw performance data;
find an edge surface in the three dimensional space by determining a curve which intersects a plane in the three dimensional space;
build a filter based on the edge surface in the three dimensional space;
perform a logical operation between raw performance data and the built filter;
determine whether the raw performance data has an invalid data value based on a result of the logical operation between the raw performance data and the built filter;
send the raw performance data to a record table in response to a determination that the raw performance data has the invalid data value; and
monitor the raw performance data over a predetermined interval to determine whether a number of raw performance data instances having the invalid value reaches a predetermined threshold counter number.

18. The system of claim 17, wherein the logical operation performed between the raw performance data and the built filter comprises a logical AND operation.

19. The system of claim 18, wherein the raw performance data is determined to have the invalid data value in response to the result of the logical AND operation between the raw performance data and the built filter having a value greater than zero

20. The system of claim 17, further comprising generating an alert in response to determining that the number of raw performance data instances having the invalid value reaches the predetermined threshold counter number.
